(19) United States
(12) Patent Application Publication
(10) Pub. No.: US 2021/0206148 A1
(43) Pub. Date: Jul. 8, 2021

(54) PACKAGING FILMS WITH RECYCLED POLYAMIDE CONTENT

(71) Applicant: Bemis Company, Inc., Neenah, WI (US)

(72) Inventors: Kimmo Lahtinen, Lempäälä (FI); Kalle Nättinen, Tampere (FI); Eeva A. Reunanen, Vesilahti (FI); Andrew J. Lischefski, Kangasala (FI)

(21) Appl. No.: 17/059,576

(22) PCT Filed: May 30, 2018
(86) PCT No.: PCT/US2018/035180

§ 371 Date: Nov. 30, 2020

(51) Int. Cl. B32B 27/08; B32B 27/34; B32B 27/30; B32B 27/32; B32B 7/12; B32B 27/18; B65D 65/40

(52) U.S. Cl. CPC B32B 27/08; B32B 2439/70; B32B 27/306; B32B 27/32; B32B 7/12; B32B 27/18; B65D 65/40; B32B 2272/00; B32B 2307/7248; B32B 2307/7244; B32B 2553/00; B32B 2250/03; B32B 2307/41; B32B 2307/738; B32B 2250/24; B32B 2307/31; B32B 2307/412; B32B 2439/46; B32B 27/34

(57) ABSTRACT

Multicomponent recyclate containing polyamide components can be utilized in packaging films, saving both material and energy resources. Migration of the odorous compounds typically resulting from overprocessed polyamide materials can be minimized or eliminated by introducing odor barrier layers on both sides of the recyclate material. The resulting films have a low odor profile and can be used to package organoleptically sensitive products.

### TECHNICAL FLUID

This disclosure relates to multilayer films containing recycled polymer content of mixed polymers. The packaging films do not exhibit offensive odor and are useful for packaging organoleptically sensitive food items.

### BACKGROUND

The production and use of multilayer films produces polymeric waste streams.

For example, some film converting processes require that the edges of the film be trimmed away in order to produce a high quality film. Similarly, when a package is produced from a film, a “skeleton” of trim waste may remain after the production. The multicomponent nature of these films prevents them from being easily recycled in large scale recycling processes. Separation of the materials from each other is typically either impossible or impractical. Reprocessing of the unseparated material often results in inefficient processing and poor product quality due to the incompatibility of the materials. Often films that are manufactured using even a small amount multicomponent polymeric waste suffer from poor mechanical properties and appearance.

The use of various types of compatibilizers has improved recycling of waste from multilayer or multicomponent films. A polymeric multicomponent film can be recycled by melt blending, allowing the compatibilizers to reduce the phase separation of the materials and introducing, the blend into part or all of a film construction via extrusion. The resulting films have appearance and physical properties appropriate for some applications. However, films that contain polyamide as part or all of the recycled content often exhibit a strong, odor, which is not rectified by compatibilizer addition. The odor can be intensified, based on certain additional components. The odor prevents the use of the films with recycled content from being used for packaging items that are organoloptically sensitive, such as food.

### SUMMARY

Low odor multilayer films with multicomponent reryclate content are disclosed herein.

A low odor packaging film can be produced, having an inner layer comprising a multicomponent recyclate, a first odor barrier layer, and a second odor barrier layer. The inner layer is located between the first and second odor barrier layers.

Each of the first odor barrier layer and the second odor barrier layer may comprise a material having an oxygen transmission rate of less than 150 cm³ 25μm/m² day when tested at 23° C. and 50% RH. The first odor barrier layer may comprise at least one of a polyamide or an ethylene vinyl alcohol copolymer. The second odor barrier layer may comprise at least one of a polyamide or an ethylene vinyl alcohol copolymer.

In addition to the multicomponent recyclate the inner layer may further comprises a compatibilizer. The inner layer may also comprise an odorous derivative of caprolactam.

The multicomponent recyclate may comprise a polyamide and a polyolefin may further comprises an ethylene vinyl alcohol copolymer. The polyolefin of the multicomponent recyclate may be a polyethylene or a polypropylene.

The first and second odor barrier layers of the packaging film reduce the transmission of odor causing compounds originating from the inner layer such that the packaging film has a low odor profile. The first and second odor barrier layers may be reducing the transmission of odorous derivatives of caprolactam. A packaged food item using the low odor packaging film may have a taste profile that is not impacted by the packaging film. Additionally, the film may have a haze value less than 30%.

Another embodiment of a low odor packaging film has a first odor barrier layer, an inner layer comprising a polyamide, polyolefin and a compatibilizer, and a second odor barrier layer. The first odor barrier layer may comprise a polyamide. The second odor harrier layer may comprise a polyamide. The inner layer is positioned between the first and second odor barrier layers. The inner layer may be directly adjacent to the first odor barrier layer and the second odor barrier layer may be directly adjacent to the inner layer. Alternatively, the low odor packaging film may additionally comprise a first polymeric adhesive layer located between the first odor barrier layer and the inner layer, and a second polymeric adhesive layer located between the inner layer and the second odor barrier layer.

When producing the low odor packaging film, the polyamide and polyolefin of the inner layer may be introduced as an unseparated multicomponent recyclate. The first and second odor barrier layers may prevent the transmission of odor causing compounds from the inner layer such that the packaging film has a low odor profile. The low odor packaging film may be thermoformable. A low odor packaging film may comprise an inner layer comprising recycled polyamide, a first odor barrier layer, and a second odor barrier layer. The inner layer may be between the first and second odor barrier layers.

### BRIEF DESCRIPTION OF THE DRAWINGS

The disclosure may be more completely understood in consideration of the following detailed description of various embodiments of the disclosure in connection with the accompanying drawings, in which:

FIG. 1 is a cross sectional view of an embodiment of a packaging film having low odor properties,

FIG. 2 is a cross sectional view of an embodiment of a packaging film having low odor properties,

FIG. 3 is a perspective view of an embodiment of as package utilizing a packaging film having low odor properties,

FIG. 4 is a cross sectional view of an embodiment of a package utilizing an a packaging film having low odor properties, and

FIG. 5 is a process flow diagram of an embodiment of a method of producing a low odor packaging film.

The figures are not necessarily to scale. Like numbers used in the figures refer to like components. It will be understood, however, that the use of a number to refer to a component in a given figure is not intended to limit the component in another figure labeled with the same number.

The drawings show some but not all embodiments. The elements depicted in the drawings are illustrative and not necessarily to scale, and the same (or similar) reference numbers denote the same (or similar) features throughout the drawings.

### DETAILED DESCRIPTION

Incorporation of polyamide containing recyclate into films has been found to cause an unpleasant odor, negatively affecting the user experience. It is generally undesirable for films, especially those used in packaging, to have strong odors. Without being bound by theory, it is believed that the odor from polyamide containing recyclate can be attributed to oxidized forms monomer and oligomers resulting from polyamide de-polymerization during high heat processing such as extrusion. Specifically, oxidized caprolactam may be the source of the odor.

When the films are used for packaging, the odor is offensive from the exterior of the package, creating an unpleasant user experience. The odor is even more of an issue as it permeates to the interior of the package, potentially causing the packaged product to take on the odor. Odors emanating from packaging are particularly problematic for food products as the odor can alter the taste and odor profile of the packaged product.

The odor becomes worse under certain circumstances. Using large amounts of recyclate can create more odor. Additionally, it has been found that if the recyclate blend also contains ethylene vinyl alcohol copolymers, the odor issue is intensified. There is an on-going need to provide low odor multilayer films with polyamide containing recyclate blends.

Previously, films have been developed that incorporate odor barrier materials and layers. These films are designed to keep an odorous compound from migrating from one side of the film to the other. For example, a packaging film with a previously designed odor barrier may prevent the packaged product from taking on odors that emanate from the environment outside of the package. The design of these films do not consider the odors that might be emanating from the packaging material itself. Typically, packaging materials are selected such that they do not contain odorous compounds.

Surprisingly, the recyclate containing multilayer, low odor films described herein do not exhibit an offensive odor. Using the prescribed materials and structure, it is possible to block the odors present in the recyclate layer(s) from migrating to either the exterior or the interior of the package. The low odor film structures provided herein reduce or prevent the odors contained in the recyclate layer of the multilayer film from affecting the taste and odor profile of the product packaged therein. As described herein, a recyclate layer can be included in a layer located between two odor barrier layers.

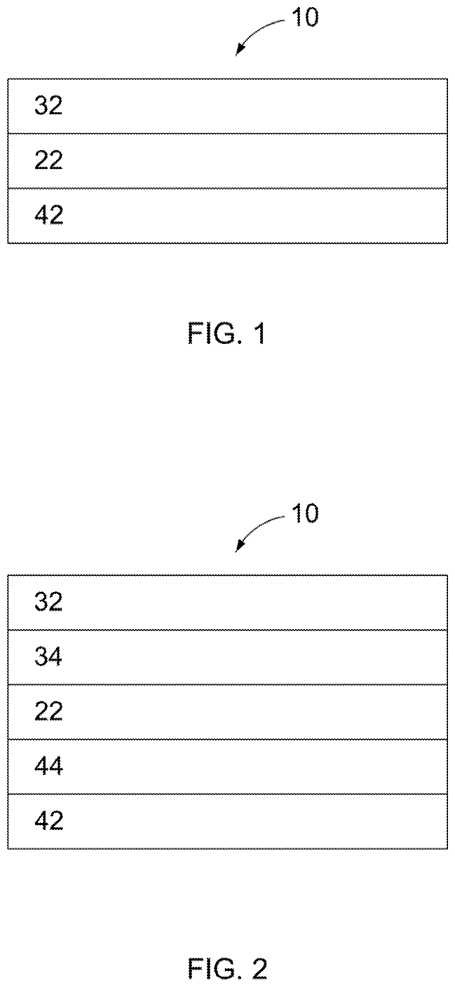

Referring now to the drawings, one embodiment of a low odor packaging film 10 is shown in FIG. 1. Inner layer 22 is polymer based and contains, inter alia, a multicomponent recyclate blend. The recyclate blend contains at least a polyamide and a polyolefin. The inner layer 22 is located between the first odor barrier layer 32 and the second odor barrier layer 42. As shown in FIG. 1, the inner layer 22 may be directly adjacent to the first and second odor barrier layers. However, in some embodiments, there may be one or more intervening layers.

Another embodiment of a low odor packaging film 10 is shown in FIG. 2. Again, the inner layer 22 is located between the first odor barrier layer 32 and the second odor barrier layer 42. In this embodiment, there are first and second polymeric adhesive layers, 34 and 44 respectively, that are located between the odor barrier layers, 32 and 42, respectively, and the inner layer 22.

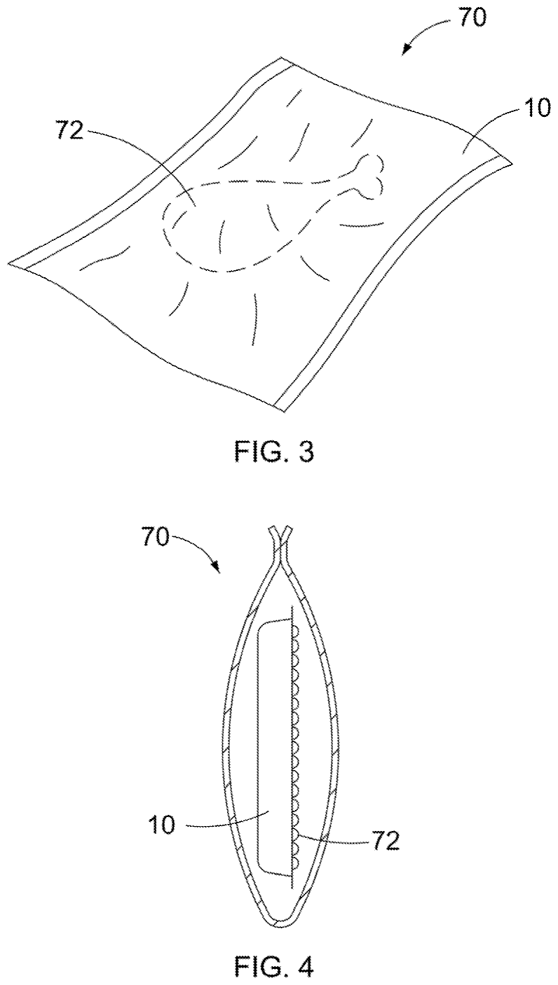

FIGS. 3 and 4 show exemplary embodiments of a packaged product 70 utilizing a low odor packaging film 10. In FIG. 3, the packaging film 10 is sealed to itself or to a different packaging film to form a bag or pouch which surrounds and encloses the product 72. In FIG. 4, the packaging film 10 is in the form of a formed tray holding the product 72, the tray plus product enclosed within an outer packing component. The outer packaging component may or may not be an embodiment of this disclosure.

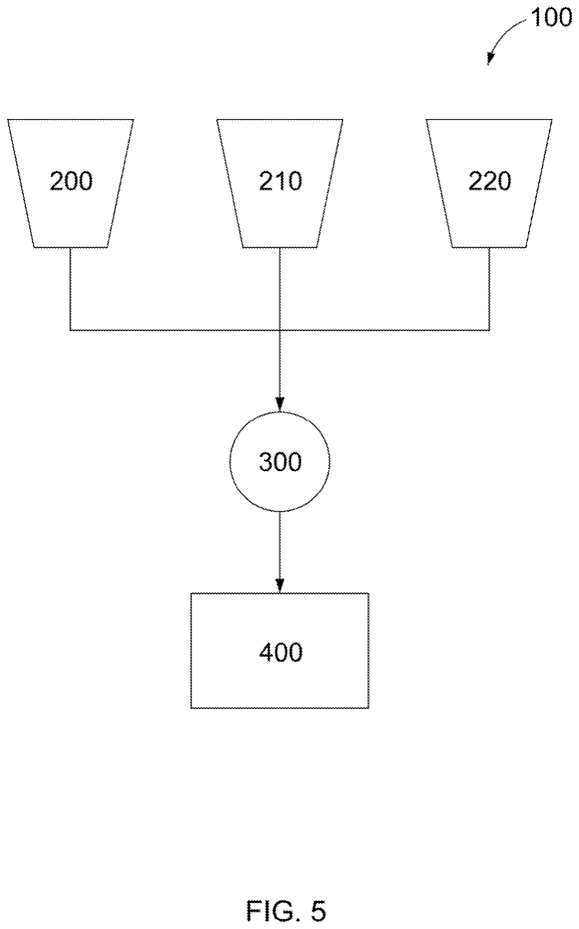

FIG. 5 is a process flow diagram for one embodiment of a method 100 for producing a low odor packaging film. The process represents a typical coextrusion technique for combining several layers of polymeric material in this process, a polyamide material is introduced into two extruders, 200 and 220, where the material is melted and mixed with any other components that may be added. Similarly, an unseparated multicomponent recyclate material is introduced into an extruder 210. The melted polymers are fed from the extruders into an extrusion die 300 where the materials are combined in a layered format such that the unseparated multicomponent recyclate material is between the polyamide material streams. The polyamide fed into extruder 200 becomes an odor barrier layer. The unseparated multicomponent recyclate fed into layer 210 becomes an inner layer. The polyamide fed into extruder 220 becomes an odor barrier layer. The layered material is extruded into a film 400 having the general structure of odor barrier layer/inner layer/odor barrier layer, in an alternative process embodiment, the materials for the two odor barrier layers could be fed from the same extruder, split prior to entering the feedblock to form the multilayer film.

As used herein, the term “film” is a material with a very high ratio of length or width to thickness. A film has two major surfaces defined by the length and width. Films typically have good flexibility and can be used for a wide variety of applications, including flexible packaging. Films may also be of thickness or material composition such that they arc semi-rigid or rigid. Films described herein are composed of various polymeric materials, but may also contain other materials such as metals or papers. Films may be described as monolayer or multilayer.

As used herein, the term “layer” refers to a thickness of material within a film that has a relatively consistent formula. Layers may be of any type of material including polymeric, cellulosic, and metallic or a blend thereof. A given polymeric layer may consist of a single polymer-type or a blend of polymers, and may be accompanied by additives. A given layer may be combined or connected to other layers to form films. A layer may be either partially or fully continuous as compared to adjacent layers or the film. A given layer may be partially or fully coextensive with adjacent layers. A layer may contain sub-layers.

As used herein “inner layer” refers to a layer of a film structure which does not reside on either major exterior surface of the film. An inner layer may consist of a single layer or may be multi-layered.

As used herein, the term “derivative” means a chemical substance related structurally to another substance and theoretically derivable from it. As it applies to some embodiments, the odor causing compounds are theoretically fragments of polyamide copolymers which have been degraded through the recycling process. As it applies to some embodiments, the odorous derivatives of caprolactam are caprolactam molecules which have been oxidized during extended high temperature exposure.

As used herein, “EVOH” refers to ethylene-vinyl alcohol copolymer. EVOH is otherwise known as saponified or hydrolyzed ethylene-vinyl alcohol copolymer, and refers to a vinyl alcohol copolymer having an ethylene comonomer. EVOH is commonly used in multilayer packaging films to provide oxygen barrier. EVOH copolymers typically used in packaging applications comprise from about 24-48 mole % ethylene EVOH can be blended with other materials to modify the properties but is typically used as the single component of a barrier layer. EVOH is typically incorporated into an inner layer of a multilayer film.

The term “polyamide” refers to a high molecular weight polymer having amide linkages (—CONH—)n which occur along the molecular chain, and includes “nylon” resins which are well known polymers having a multitude of uses including utility as packaging films, bags, and casings. Examples of nylon polymeric resins for use in food packaging and processing include: nylon 66, nylon 610, nylon 66/610, nylon 6/66, nylon 11, nylon 6, nylon 66T, nylon 612, nylon 12, nylon 6/12, nylon 6/69, nylon 46, nylon 6-3-T, nylon MXD-6, nylon MXDI, nylon 12T and nylon 6I/6T disclosed at 21 CFR § 1477.1500. Examples of polyamides include nylon homopolymers and copolymers such as those selected form the group consisting of nylon 4,6 (poly(tetramethylene adipamide)), nylon 6 (polycaprolactam), nylon 6,6 (poly(hexamethylene adipamide)), nylon 6,9(poly(hexamethylene nonanediamide)), nylon 6,10 (poly(hexamethylene sebacamide)), nylon 6,12 (poly(hexamethylene dodecanediamide)), nylon 6/12 (poly(caprolactam-co-dodecanediamide)), nylon 6,6/6 (poly(hexamethylene adipamide-co-caprolactam)), nylon 66/610 (e.a., manufactured by the condensation of mixtures of nylon 66 salts and nylon 610 salts), nylon 6/69 resins (e.g., manufactured by the condensation of epsilon-caprolactam, hexamethylenediamine and azelaic acid), nylon 11 (polyundecanolactam), nylon 12 (polylauryllactam) and copolymers or mixtures thereof. Polyamides are preferably selected from nylon compounds approved for use in producing articles intended for use in processing, handling, and packaging food.

Polyamide is used in films for food packaging and other applications because of its unique physical and chemical properties. Polyamide can be used by itself (i.e. monolayer biaxially oriented polyimide webs) or in composite structures, blended or layered with other polymers. Polyamide is selected as a material to improve temperature resistance, abrasion resistance, puncture strength and/or barrier of films. Properties of polyamide-containing films can be modified by selection of a wide variety of variables including copolymer selection, converting methods (e.g. coextrusion, lamination, and coating), and post converting processing such as orientation. Often, polyamide layers are combined with layers containing materials belonging to other polymer families, such as polyolefin, polymeric adhesives, and barrier polymers, to produce a film appropriate for specific applications. It is not uncommon for packaging films to contain blends or combinations of layers that include polymers from many families.

The term “polymeric adhesive layer,” “adhesive layer,” or “tie layer,” refers to a layer or material placed in or on one or more layers to promote the adhesion of that layer to another surface. Preferably, adhesive layers are positioned between two layers of a multilayer film to maintain the two layers in position relative to each other and prevent undesirable delamination. Unless otherwise indicated, an adhesive layer can have any suitable composition that provides a desired level of adhesion with the one or more surfaces in contact with the adhesive layer material. Optionally, an adhesive layer placed between a first layer and a second layer in a multilayer film may comprise components of both the first layer and the second layer to promote simultaneous adhesion of the adhesive layer to both the first layer and the second layer to opposite sides of the adhesive layer.

The term “oxygen transmission rate” (OTR) is defined herein as the amount of oxygen that will pass through a material in a given time period. OTR may be defined for a specific oxygen barrier material, and is typically defined with an upper and/or lower limit using units of cm³ 24μm/² day, or similar units, when measured at a defined temperature and humidity. Oxygen barrier materials useful in odor barrier layers may have an OTR value of less than 150 cm³ 25μm/m² day when tested at 23° C. and 50% RH.

Additionally, OTR may be defined for a multilayer film. The OTR of a multilayer film is the result of the sequential contribution of each layer within the film. OTR of a multilayer film is typically defined with an upper and/or lower limit using units of cm³/m² day, or similar units, when measured at a defined temperature and humidity. Multilayer films which are useful as low odor packaging films may have an OTR value of from about 0.001-200 cm³/m² over 24 hr at 80% R.H. and 23° C. Oxygen transmission may be measured according to ASTM D-3985-81 which is incorporated herein by reference.

As used herein, the term “recyclate” or “recycled” refers to a polymer based material being, used to form an extruded layer of a film, the polymer based material having been previously formed into a product (e.g., film) by an extrusion process. The recyclate may be subjected to other processing steps, such as pelletization, between the extrusion that formed the initial product and the extrusion step that now uses the recyclate. A “multicomponent recyclate” has more than one type of polymer present, which may be sourced from a single previous product, such as a multilayer film, or sourced from more than one previous product.

For a given recyclate, the materials of the initial polymer product may have been substantially unseparated such that any materials that may have been in separate layers of the initial film remained together in bonded layers and are now intermingled or mixed or blended in a single layer of the current film. This type of recyclate is referred to herein as an “unseparated multicomponent recyclate”.

As used herein, “odor barrier material,” or “odor barrier layer” refers to a material or layer of a film having properties that block or slow the transmission of odorous compounds. Traditionally, odor barrier layers have been used to prevent the transmission of a compound through a film, containing that compound to one side of the film. As used herein, the odor barrier layers are being used in combination (at least two odor barrier layers) to contain odorous compounds within the film. The odorous compounds introduced into the multilayer film as part of the recyclate containing inner layer are prevented, or significantly blocked, from migrating out of the film at both major surfaces. The odor barrier materials have properties that slow the migration of oxidized caprolactam such that a product packaged within the multilayer film will not have the odor or flavor profile significantly affected by the odor.

As used herein, “polyolefin” refers to polyethylene homopolymers, polyethylene copolymers, polypropylene homopolymers or polypropylene copolymers.

As used herein, “polyethylene” refers to polymers that include an ethylene linkage. Polyethylenes may be a homopolymer, copolymer or interpolymer. Polyethylene copolymers or interpolymers may include other types of polymers (i.e., non-polyethylene polymers). Polyethylenes may have functional groups incorporated by grafting or other means. Polyethylenes include, but are not limited to, low-density polyethylene (LDPE), linear loss density polyethylene (LLDPE), medium-density polyethylene (MDPE), ultra-low density polyethylene (ULDPE), high-density polyethylene (HDPE), cyclic-olefin copolymers (COC), ethylene vinyl acetate copolymers (EVA), ethylene acrylic acid copolymers (EAA), ethylene methacrylic acid copolymers (EMAA), neutralized ethylene copolymers such as ionomer, and maleic anhydride grafted polyethylene (MAHgPE).

As used herein, “polypropylene” refers to polymers that are derived from monomers of propylene. Polypropylenes may be a homopolymer, copolymer or interpolymer. Polypropylene copolymers or interpolymers may include other types of polymers (i.e. non-polypropylene polymers). Polypropylenes may have functional groups incorporated by grafting or other means. Polypropylenes include, but are not limited to, propylene-ethylene copolymers, ethylene-propylene copolymers, and maleic anhydride grafted polypropylenes (MAHgPP).

As used herein, “odor causing compounds” refers to migratory molecules that may be present within an inner layer of a film. These compounds may be present due to conditions present during extrusion which can promote depolymerization of the polymers. Alternatively, the compounds may be derivatives of monomer that is present in the polymer from the polymerization process (i.e. carprolactam is present in nylon-6). In either case, the compounds are theorized to be oxidative derivatives of relatively small molecules. In any case, the compounds are detectable by smell or taste.

Polymer materials are typically subjected to high heat when shaped and formed into usable products, i.e. extrusion. Recycled polymers are repeatedly subjected to incidents of high heat and excessive shear stress, which can cause degradation of the polymer. Under these conditions oxidation may occur, and specifically may happen to any monomers and oligomers that may be a result of depolymerization or remaining from the original polymerization of the polymer. Oxidized materials can result from the repeated extrusion processes. Polyamides and specifically nylon-6 can be particularly susceptible to producing odor causing compounds, specifically odorous derivatives of caprolactam (i.e. oxidized caprolactam).

Without being bound by theory, the odors generated during reprocessing of recycled polyamide are typically attributed to oxidized caprolactam. The odor causing materials may be oxidized caprolactam, or similar monomers or oligomers, which are present in nylon-6 as a result of incomplete polymerization. Alternatively, the odor causing materials may be oxidized components that are a result of polyamide depolymerization fragments that result from overprocessing.

Some embodiments of the low odor packaging film have an inner layer comprising a recycled polyamide material. The inner layer may have a material that is a multicomponent recyclate. The inner layer may have a material that is an unseparated multicomponent recyclate. The multicomponent recyclate may contain a polyamide and a polyolefin. The inner layer may comprise more than 5%, 10%, 20%, 40%, 60% or 80% recyclate, The inner layer may comprise 100% recyclate. The inner layer may comprise at least 1%, 5%, 10%, 15%, 20% or 25% polyamide. The inner layer may comprise at least 50% polyamide.

The result of the use of recycled polymers, specifically a multicomponent recyclate, is that the inner layer of the film also comprises odor causing compounds, specifically odorous derivatives of caprolactam. These odor causing compounds may be transient in nature, such that they easily travel through non-barrier polymer structures and emanate from the film. If the film is used as a packaging material, the odor can be offensive from both the exterior and interior. The odors that emanate from the interior of the film may even impart off-flavor and off-taste to the product packaged therein. By using the claimed film structure, the odor causing compounds can be contained within the film, eliminating any issues. By using the films disclosed herein, a packaged food product may have an odor and taste profile that is not impacted by the film. By using the low odor recyclate containing films disclosed herein, a food product may have a taste profile similar to the taste profile after packaging in a similarly formulated film without recyclate. By using the low odor recyclate containing films disclosed herein, a food product may have an odor profile similar to the odor profile after packaging in a similarly formulated film without recyclate.

The multicomponent recyclate may also contain ethylene vinyl alcohol copolymer (EVOH). It has been found that extrusion of a multicomponent recyclate that includes both polyamide and EVOH tends to exhibit very high odor levels. In this case, it is even more valuable to produce the film in the manner described herein. By using odor blocking layers on each side of the recyclate containing layer, the value, of the recyclate can be optimized while still producing a low odor film that can be used for applications in which low odor is required.

The inner layer of some embodiments may also contain a compatibilizer. The compatibilizer may be introduced as part of the recyclate, or may be added as a separate component to the inner layer. Any compatibilizer known in the art may be used as an aid to allow the components of the inner layer to become a more homogenous blend.

Compatibilizers can be added to the recyclate to assist in homogenizing the material blend. Compatibilizers are functional additives that can be added to blends of incompatible materials to assist in achieving a blend with improved mechanical properties. The incompatible materials may be from recyclate blends or other sources. Often, a blend of incompatible materials has insufficient properties for end use applications. Functional additives can improve this compatibility. The general principle of compatibilization is to reduce interfacial energy between two polymers in order to increase adhesion. Generally, adding a polymer compatibilizer also results in liner dispersion, as well as more regular and stable morphologies. Adding compatibilizers generally increases mechanical performance and improves appearance properties. Examples of useful compatibilizers are Fusabond® OE226 (available from DuPont™) and Orevar® OE825 (available from Arkema).

The inner layer may also contain polymeric adhesive materials. Specifically, if the inner layer is directly adjacent to the odor barrier layers, a polymeric adhesive material in the inner layer may aid in interlayer adhesion. Alternatively, a polymeric adhesive may be in intervening layers between the inner layer and the odor barrier layers. Depending on the chemical makeup of the inner layer and the odor barrier layers, and also depending on the interlayer adhesion performance criteria for the application, the film may not require any polymeric adhesive components.

A polymeric adhesive may comprise a polyolefin copolymer with maleic anhydride grafted functionality. In some embodiments the polymeric adhesive is a maleic anhydride grafted polyethylene (MAHgPE) polymer with a melt index from 0.5 to 10 g/10 min.

The inner layer may be of any thickness. Preferably, the inner layer may be between 0.01 and 50% or between 0.1 and 25% or between 1 and 15% of the thickness of the entire packaging film structure. The inner layer may have a thickness greater than 0.1, 1 or 10 micron.

The films have a first and second odor barrier layer, located on opposite sides of the inner layer. In this manner, the multicomponent recyclate that is in the inner layer is between the first and second odor barrier layer. The odor barrier layers and the inner layer may be in direct contact. with each other or there may he intervening layers. Either or both of the first and second odor barrier layers may be located on the exterior surface of the film, or additional layers may be located exterior to one or both of the odor barrier layers (i.e. closer to one of the major surfaces of the film).

The odor barrier layers contain materials that will significantly slow or prevent the transmission of any odor causing compounds from the inner layer of the film. In this manner, odors are trapped within the film between the odor barrier layers and the film has a low odor profile. The odor profile of the low odor film is similar to a packaging film with identical components with the exception arm recyclate content. The odor barrier materials may be of any general composition, including polymeric materials, metals, inorganics, or combinations thereof. Polymeric odor barrier materials may be any that provide barrier to odorous compounds, including, but not limited to polyesters, polyamides or cyclic olefin copolymers (COC). Metals that may be used for the odor barrier include, but are not limited to, thin aluminum foils, vacuum deposited metal coatings and transparent metal oxides. Inorganics include, but are not limited to exfoliated nano clays.

Odor barrier materials that can be used in the odor barrier layers include those that are generally considered good oxygen barrier materials, as these are similar and analogous properties. In this light, materials that can be used for the odor barrier material include EVOH, polyvinylidene chloride (PVdC) copolymers, polyamide copolymers, aluminum oxide or silicon oxide coatings, aluminum alloy foils, vacuum deposited metals, exfoliated clay matrices, and any other materials commonly used in high barrier packaging structures for the purpose of oxygen transmission blocking. Preferably, the odor barrier layers comprise polyamide or EVOH copolymers.

The oxygen transmission rate of the odor barrier materials may be less than 150 cm³ 25μm/m² day when tested at 23C and 50% RH using ASTM F1927-14 Standard Test Method for Determination of Oxygen Gas Transmission Rate, Permeability and Permeance at Controlled Relative Humidity Through Barrier Materials Using a Coulometric Detector (2014). Some embodiments may utilize odor barrier materials with an oxygen transmission rate of less than 125, 100 80, 60 40, 20, 10 5, 2 or 1 cm³ 25μm/m² day when tested at 23° C. and 50% RH.

The odor barrier materials may be blended with other components, as may be required for other processing requirements, performance characteristics or economic value. The odor barrier layers may have any thickness necessary as long as the layers function as required for odor migration prevention. The odor barrier layers may be split into multiple layers, such as polyamide/polymeric adhesive/polyamide, that effectively act together to block the odor migration. The odor barrier layers may have the same or different composition,

Odor absorbers may be used within the multilayer film. However, the addition of conventional odor absorbers can degrade the transparency and mechanical properties of the film. The use of absorbers is preferably limited.

The low odor films that contain reeyclate content and at least two odor barrier layers may also comprise other layers as necessary for the application in which the film is used. For example, films used for packaging may have an exterior layer that has abuse resistance properties or specialized appearance properties. Layers and materials throughout the film may be required to make the film structure amenable to thermoforming. Ink, pigments or other materials may be added to the film structure for graphical improvements, light blocking or to meet other requirements. In some embodiments, additional layers or materials may be added to enhance moisture barrier properties of the film.

The low odor films may be opaque, semi-transparent or transparent to visible light. In many cases, it is desirable tbr the film to be transparent such that a product packaged in the film is clearly visible. Haze is the scattering of light as it passes through a transparent material, resulting in poor visibility and/or glare. It is preferred that the haze level of the low odor film would be less than 30% when measured according to ASTM D1003 (Haze and Luminous Transmittance of Transparent Plastics) method B. The haze level could be less than 50%, 40%, 25%, 20%, 15%, 10% or even 5%.

In many embodiments, the low odor film is required to be heat sealable, specifically if the film is to be used for packaging applications. Heat sealing requires portions of the film structure (i.e. the exterior layers) to be heat resistant and portions of the film structure (i.e. the sealant layer) to be capable of forming a strong seal with another packaging component. Scalable films are widely documented and can be any known formula and structure combination to create heat seals required for the application. Alternatively, the exterior layers of the film may be formulated for other types of sealing, such as ultrasonic sealing.

The films described herein may be produced by any means known. The layers of the structures described may be created and combined by way of a multilayer coextrusion process. All, some or none of the layers may be combined by coextrusion. Layers and materials may be added to the film structure by means of adhesive lamination, extrusion coating, vacuum metallization, solution coating, or printing. Other known processes may be utilized in production of the final film structure, as long as the spirit of embodiments disclosed herein is met, namely, the inclusion of recyclate in an inner layer of a film that uses odor barrier layers to enable a low odor profile film.

The recyclate is most easily introduced into an inner layer of the film structure by way of extrusion. The recyclate may be introduced in the form of chopped film, pellets or any other format, as it is fed into an extruder for melting and mixing. Other components may be added to the inner layer at the point of melting and mixing. These other components may include a compatibilizer or a polymeric adhesive material. Any other materials may be added to the inner layer. The inner layer may comprise greater than 25%, 30%, 35%, 40%, 45% or 50% recyclate blend. The inner layer may comprise 5%, 10%, 15% or 20% compatibilizer. The inner layer may comprise greater than 1%, 2%, 5%, 10%, 15%, 20% or 25% polyamide.

The film production may include other processes to enhance the functionality or overall qualities of the film. For example, the film may be electron beam imidiated to cross-link some of the component therein, as is known. The film may have one or more layers scored by mechanical or high energy (laser) means. The resulting film may have any types of properties including high slip, low slip, high gloss, matte finish, heat shrinkability, thermoformability, high stiffness, low stiffness, lap sealability, easy openability, reclosability, etc., as long as the spirit of the embodiments described herein is not prevented.

In some cases, the multilayer films described herein are used as packaging materials. The films disclosed herein may be used independently to create the package or may be combined with other packaging components. In either case, the package may be hermetically sealed around the product for protection. The multilayer films described herein may be used as packaging components such as trays, liners, zippers, etc.

The product packaged in a low odor packaging film may be, but is not limited to, food items, including dry or liquid products, personal care items, pet foods, medical products, pharmaceuticals, first aid items, nutritional aids, or beverages. The package may take any number of forms including pouches, bags, trays/lids, clamshells, boxes or bottles. The packaged product may be a single serving or may have multiple servings. The packaging may have additional features such as a zipper for reclose.

Products packaged within the low odor packaging film advantageously are not affected with respect to odor or taste. The effect that the low odor packaging films that contain recyclate content, as disclosed herein, have on the product package therein is not significantly different than the effect that a similar packaging film without recyclate content would have on the product. The packaging film serves to protect the product therein throughout the packaging, storage, distribution, retailing and consumer use life time. Due to this extended relationship between the product and package, there may be some influence of the package on the product. However, the films disclosed herein do not have a negative affect the product packaged therein due to the recyclate content, especially as it relates to odor or taste profiles. The food product has a similar taste before and after exposure to the low odor film.

Products packaged within packaging films can be negatively affected by the odor of the packaging in a number of ways. Odor can emanate from a packaging film, and be offensive to a user of the packaged product, even before the packaging is opened. Odors apparent from outside of a package is typically avoided, especially in retail environments. Odor can emanate from a packaging film toward the interior of the package, making the internal environment of the package (i.e. headspace) and/or the product within the package have an offensive odor. As a user opens the package, an odor from within the package can be especially strong as it exits the package. Odors internal to the package are to be avoided when the product inside is meant to be consumed or otherwise used by humans or pets. Odors can negatively affect the user experience of a product if it is offensive.

It is also noted that the concepts discussed herein could be applied to other multilayer packaging components beyond films. For example, packaging components may be blow molded, compression molded or injection molded and may also benefit from the use of odor barrier layers to improve the implementation of recycled content therein.

### Examples & Data

The following examples are offered for illustrative purposes only, and is not intended to limit the scope of the claims in any way. Indeed, various modifications of the invention in addition to those shown and described herein will become apparent to those skilled in the art from the foregoing description and the following examples and fall within the scope of the appended claims.

Coextruded films of the formulas listed in TABLES 1 & 2 were produced for testing purposes. The films produced were subjected to various odor analysis, thermoforming and physical testing.

Example 1 represents the low odor packaging film disclosed herein. The multilayer test film was produced using a standard blown film coextrusion process. In this embodiment of the low odor packaging film, the first odor barrier layer of the film consisted of a single layer of nylon-6 with standard slip and antiblock additives. The first odor barrier layer was also the exterior surface of the packaging film produced.

The inner layer of Example 1 consisted of a single layer containing industrial recyclate, ULDPE, 10% polymeric adhesive and 4% compatibilizer. The industrial recyclate was derived from a multilayer packaging film that contained layers of polyamide, polyethylene, EVOH and polymeric adhesive. The industrial recyclate had been repelletized prior to use in the Example 1 film. The inner layer was located directly adjacent to the first odor barrier layer.

The second odor barrier layer, located directly adjacent to the inner layer, consisted of two layers of nylon-6, separated by a polymeric adhesive layer, as shown in TABLE 1. The remainder of the structure of Example 1 can be seen in TABLE 1. Reference A was produced in the same manner as Example 1, but did not contain any industrial recyclate, also shown in TABLE 1.

TABLE 1
Testing Film Formulas

| Layer | Example 1 | | Reference A | |
|---|---|---|---|---|
| 1 | PA 6 (slip, antiblock) | 28.6 g/m² | PA 6 | 28.6 g/m² |
| 2 | 46% Recyclate | 33.5 g/m² | 90% ULDPE | 33.5 g/m² |
| | 40% ULDPE | | 10% Polymeric | |
| | 10% Polymeric | | Adhesive | |
| | Adhesive | | | |
| | 4% Compatibilizer | | | |
| 3 | PA 6 | 18.1 g/m² | PA 6 | 18.1 g/m² |
| 4 | 90% ULDPE | 18.5 g/m² | 90% ULDPE | 18.5 g/m² |
| | 10% Polymeric | | 10% Polymeric | |
| | Adhesive | | Adhesive | |
| 5 | PA 6 | 18.1 g/m² | PA 6 | 18.1 g/m² |
| 6 | 90% ULDPE | 33.5 g/m² | 90% ULDPE | 33.5 g/m² |
| | 10% Polymeric | | 10% Polymeric | |
| | Adhesive | | Adhesive | |
| 7 | ULDPE (slip, antiblock) | 46.7 g/m² | ULDPE | 46.7 g/m² |

Samples of the Example and Reference A films were therinolonned into a deep draw package configuration using heat and vacuum applied on a Multivac packatina machine. Upon thermoforming the films, it was observed that both films exhibited good forming and good appearance. The addition of the industrial recyclate did not have detrimental effects on the packaging film.

An odor panel was assembled to assess Example 1 using Reference A for comparison. Film samples were slit from the produced web and placed in 500 ml Erlenmeyer glass cylinders. The entire container was covered with foil to protect the samples from light and to prevent any odors from escaping. The odor panel was conducted in a fashion similar to DIN 10955 standard. The odor panel of 6 people were not able to distinguish any odor difference between the test film, Example 1, and the reference film, Reference A.

Comparative 1 and Reference B films were produced to demonstrate the necessity of odor barrier layers on both sides of the inner layer containing recyclate. The industrial recyclate was included in layer 4 of Comparative 1, as shown in TABLE 2.

The structure of Comparative 1 contained a layer of nylon-6, a layer of polymeric adhesive and a layer of MDPE, all exterior to the recyclate layer. The layer located interior to the recyclate contained EVA and LLDPE, and did not contain an odor barrier material.

The material of Reference B was produced in the same fashion as Comparative 1. Reference B has a similar construction and formula, but without the recyclate, polymeric adhesive and compatibilizer materials, as shown in TABLE 2.

TABLE 2
Testing Film Formulas

| Layer | Comparative 1 | | Reference B | |
|---|---|---|---|---|
| 1 | PA 6 (slip, antiblock) | 39.9 g/m² | PA 6 | 39.9 g/m² |
| 2 | 80% LDPE | 4.6 g/m² | 80% LDPE | 4.6 g/m² |
| | 20% Polymeric | | 20% Polymeric | |
| | Adhesive | | Adhesive | |
| 3 | MDPE | 9.2 g/m² | MDPE | 9.2 g/m² |
| 4 | 46% Recyclate | 36.7 g/m² | 65% LLDPE | 36.7 g/m² |
| | 40% LLDPE | | 35% LDPE | |
| | 10% Polymeric | | | |
| | Adhesive | | | |
| | 4% Compatibilizer | | | |
| 5 | 70% EVA | 9.2 g/m² | 70% EVA | 9.2 g/m² |
| 6 | 30% LLDPE | | 30% LLDPE | |
| | (slip, antiblock) | | | |

Odor testing was again completed as described above using Comparative 1 as the test film and Reference B as the reference film. The odor panel used the following rating system for comparing the test films:

| | |
|---|---|
| No odor difference | 0 |
| Small odor difference | 1 |
| Clear odor difference | 2 |
| Strong odor difference | 3 |

The average of the scores given for Comparative 1 was 2.29, when compared to Reference B indicating that a film with only one odor barrier layer has a noticeably different odor and may be unacceptable for applications in which low odor is important.

### Embodiments

Reference throughout this specification to “one embodiment,” “certain embodiments,” “one or more embodiments” or “an embodiment” means that a particular feature, structure, material, or characteristic described in connection with the embodiment is included in at least one possible embodiment. Thus, the appearances of the phrases such as “in one or more embodiments,” “in certain embodiments,” “in one embodiment” or “in an embodiment” in various places throughout this specification are not necessarily referring to the same embodiment. Furthermore, the particular features, structures. materials, or characteristics may be combined in any suitable manner in one or more embodiments.

Embodiment A: A low odor packaging film comprising:
an inner layer comprising a multicomponent recyclate,
a first odor barrier layer, and
a second odor barrier layer,
wherein the inner layer is between the first and second odor barrier layers.

Embodiment B: A low odor packaging film according any other embodiment wherein the first odor barrier layer and the second odor barrier layer each comprise a material having an oxygen transmission rate of less than 150 cm³ 25μm/m² day when tested at 23° C. and 50% RH.

Embodiment C: A low odor packaging film according to any other embodiment wherein the first odor barrier layer comprises at least one of a polyamide or an ethylene vinyl alcohol copolymer.

Embodiment D: A low odor packaging film according to any other embodiment wherein the second odor barrier layer comprises at least one of a polyamide or an ethylene vinyl alcohol copolymer.

Embodiment E: A low odor packaging film according to any other embodiment wherein the inner layer further comprises a compatibilizer.

Embodiment F: A low odor packaging film according to any other embodiment wherein the inner layer further comprises an odorous derivative of caprolactam.

Embodiment G: A low odor packaging film according to any other embodiment wherein the multicomponent recyclate comprises a polyamide and a polyolefin.

Embodiment H: A low odor packaging film according to any other claim wherein the polyolefin is a polyethylene or a polypropylene.

Embodiment I: A low odor packaging film according, to any other embodiment wherein the multicomponent recyclate further comprises an ethylene vinyl alcohol copolymer.

Embodiment J: A low odor packaging film according to any other embodiment wherein the first and second odor barrier layers reduce the transmission of odor causing compounds originating from the inner layer such that the packaging film has a low odor profile.

Embodiment K: A low odor packaging film according to any other embodiment wherein the first and second odor barrier layers reduce the transmission of the odorous derivative of caprolactam from the inner layer such that the packaging film has a low odor profile.

Embodiment L: A low odor packaging film according to any other embodiment wherein the film has a haze value less than 30%.

Embodiment M: A low odor packaging film comprising a first odor barrier layer, an inner layer comprising a polyamide, a polyolefin and a compatibilizer, and a second odor barrier layer, wherein the inner layer is positioned between the first and second odor barrier layers.

Embodiment N: A low odor packaging film according to Embodiment M, wherein the first odor barrier layer comprises a polyamide and the second odor barrier layer comprises a polyamide.

Embodiment O: A low odor packaging film according to any other embodiment wherein the inner layer is directly adjacent to the first odor barrier layer and the second odor barrier layer is directly adjacent to the inner layer.

Embodiment P: A low odor packaging film according to Embodiment M, further comprising a first polymeric adhesive layer located between the first odor barrier layer and the inner layer, and a second polymeric adhesive layer located between the inner layer and the second odor barrier layer.

Embodiment Q: A low odor packaging film according to any other embodiment wherein the first and second odor barrier layers prevent the transmission of odor causing compounds from the multicomponent recyclate layer such that the packaging film has a low odor profile.

Embodiment R: A low odor packaging film according to any other embodiment wherein the film is thermoformable.

Embodiment S: A method of producing a low odor packaging film according to any of Embodiments M, N, O, P or R, wherein the polyamide and the polyolefin of the inner layer are introduced as an unseparated multicomponent recyclate.

Embodiment T: A low odor packaging film comprising an inner layer comprising recycled polyamide, a first odor barrier layer, and a second odor barrier layer, wherein the inner layer is between the first and second odor barrier layers.

Unless otherwise indicated, all numbers expressing sizes, amounts, ranges, limits, and physical and other properties used in the present application are to be understood as being preceded in all instances by the term “about”. Accordingly, unless expressly indicated to the contrary, the numerical parameters set forth in the present application are approximations that can vary depending on the desired properties sought to be obtained by a person of ordinary skill in the art without undue experimentation using the teachings disclosed in the present application.

The description, examples, embodiments, and drawings disclosed are illustrative only and should not be interpreted as limiting. The present invention includes the description, examples, embodiments, and drawings disclosed but it is not limited to such description, examples, embodiments, or drawings. As briefly described above, the reader should assume that features of one disclosed embodiment can also be applied to all other disclosed embodiments, unless expressly indicated to the contrary. Modifications and other embodiments will be apparent to a person of ordinary skill in the packaging arts, and all such modifications and other embodiments are intended and deemed to be within the scope of the present invention.

1. A low odor packaging film comprising:
a) an inner layer comprising a multicomponent recyclate,
b) a first odor barrier layer, and
c) a second odor barrier layer,
wherein the inner layer is between the first and second odor barrier layers, and wherein the first odor barrier layer and the second odor barrier layer each comprise a material having an oxygen transmission rate of less than 150 cm³ 25μm/m² day when tested at 23° C. and 50% RH.

2. (canceled)

3. A low odor packaging film according to claim 1 wherein the first odor barrier layer comprises at least one of a polyamide or an ethylene vinyl alcohol copolymer.

4. A low odor packaging film according to claim 1 wherein the second odor barrier layer comprises at least one of a polyamide or an ethylene vinyl alcohol copolymer.

5. A low odor packaging film according to claim 1 wherein the inner layer further comprises a compatibilizer.

6. A low odor packaging film according to claim 1 wherein the inner layer further comprises an odorous derivative of caprolactam.

7. A low odor packaging film according to claim 1 wherein the multicomponent recyclate comprises a polyamide and a polyolefin.

8. A low odor packaging film according to claim 7 wherein the polyolefin is a polyethylene or a polypropylene.

9. A low odor packaging film according to claim 7 wherein the multicomponent recyclate further comprises an ethylene vinyl alcohol copolymer.

10. A low odor packaging film according to claim 1 wherein the first and second odor barrier layers reduce the transmission of odor causing compounds originating from the inner layer such that the packaging film has a low odor profile.

11. A low odor packaging film according to claim 6 wherein the first and second odor barrier layers reduce the transmission of the odorous derivative of caprolactam from the inner layer such that the packaging film has a low odor profile.

12. A low odor packaging film according to claim 1 wherein the film has a haze value less than 30%.

13. A low odor packaging film comprising:
a) a first odor barrier layer,
b) an inner layer comprising a polyamide, a polyolefin and a compatibilizer, and
c) a second odor barrier layer,
wherein the inner layer is positioned between the first and second odor barrier layers.

14. A low odor packaging film according to claim 13 wherein the first odor barrier layer comprises a polyamide and the second odor barrier layer comprises a polyamide.

15. A low odor packaging film according to claim 13 wherein the inner layer is directly adjacent to the first odor barrier layer and the second odor barrier layer is directly adjacent to the inner layer.

16. A low odor packaging film according to claim 13 further comprising:
a) a first polymeric adhesive layer located between the first odor barrier layer and the inner layer, and
b) a second polymeric adhesive layer located between the inner layer and the second odor barrier layer.

17. A low odor packaging film according to claim 13 wherein the first and second odor barrier layers prevent the transmission of odor causing compounds from the inner layer such that the packaging film has a low odor profile.

18. A low odor packaging film according to claim 13 wherein the film is thermoformable.

19. A method of producing low odor packaging film according to claim 13 wherein the polyamide and polyolefin of the inner layer are introduced as an unseparated multicomponent recyclate.

20. A low odor packaging film comprising:
a) an inner layer comprising recycled polyamide,
b) a first odor barrier layer, and
c) a second odor barrier layer,
wherein the inner layer is between the first and second odor barrier layers.
